(19) United States
(12) Patent Application Publication
(10) Pub. No.: US 2023/0162225 A1
(43) Pub. Date: May 25, 2023

(54) COMPUTER AND METHOD FOR REWARDING POINT ACCUMULATING AND REDEEMING

(71) Applicant: DPOINTS LLC, Mineola, NY (US)

(72) Inventor: Stanley Chang, Mineola, NY (US)

(21) Appl. No.: 17/533,714

(22) Filed: Nov. 23, 2021

(51) Int. Cl. G06Q 30/02

(52) U.S. Cl. CPC G06Q 30/0232; G06Q 30/0236; G06Q 30/0239

(57) ABSTRACT

A rewarding point accumulating method, comprising: receiving a customer id code and transaction information from a vendor device; verifying the received customer id code; updating rewarding point information of a customer according to the customer id code and the transaction information; updating rewarding point information of a vendor according to the transaction information, wherein the vendor is corresponding to the vendor device; and notifying the vendor device with regard to the updating of the rewarding point information of the vendor.

### FIELD OF THE INVENTION

The present invention relates to electronic sales system, and more particularly, to rewarding points management system.

### BACKGROUND OF THE INVENTION

Rewarding points are usually provided by a vendor to a customer who finishes a purchase of service or goods. For example, a toy vendor may provide 3 rewarding points to a child customer who buys a 100-dollar toy car. After that, the child customer may redeem the 3 rewarding points for 5 dollars if he buys a toy boat. The rewarding points given in a previous transaction encourage the customer to buy in a next transaction from the same vendor. Similarly, the “rewarding points” may be called in different names, such as “royalty points”, “point”, “star”, “reserve point”, “cyber money” or the like. In the present application, “rewarding point” or “point” is used to represent these kinds of incentive-laden programs.

However, kinds of services or goods provided by a particular vendor may be quite limited. Customers may not need to buy from the vendor in a short time period. Customers may think that the rewarding points issued by the particular vendor are not beneficial. This reduces incentive of the rewarding point program of the particular vendor. Therefore, there exists a need to provide an electronic computer system to maintain or to increase incentives of rewarding point program.

### SUMMARY OF THE INVENTION

One solution provided by the present application is to increase chances to redeem rewarding points. In this solution, multiple vendors join an alliance to provide accumulating and redeeming of common rewarding points. Since kinds of services and goods as well as places of the alliance are larger than those of one vendor, it increases commercial competitiveness of the alliance vastly and non-linearly proportional to numbers of vendors in the alliance.

According to an embodiment of the present application, a rewarding point accumulating method is provided. The rewarding point accumulating method, comprising: receiving a customer id code and transaction information from a vendor device; verifying the received customer id code; updating rewarding point information of a customer according to the customer id code and the transaction information; updating rewarding point information of a vendor according to the transaction information, wherein the vendor is corresponding to the vendor device; and notifying the vendor device with regard to the updating of the rewarding point information of the vendor.

According to an embodiment of the present application, a rewarding point redeeming method is provided. The rewarding point redeeming method, comprising: receiving a vendor id code and redeeming information from a customer device; verifying the received vendor id code; updating rewarding point information of a customer according to the redeeming information, wherein the customer is corresponding to the customer device; updating redeeming information of a vendor according to the vendor id code and the redeeming information; and notifying the customer device with regard to the updating of the rewarding point information of the customer.

According to an embodiment of the present application, a server computer for rewarding point accumulating is provided. The server computer comprising: a network interface, configured to connect to a network; a storage device, configured to store data; and a processor, coupled to the network interface and the storage device, configured to execute instructions stored in a non-volatile memory for fulfilling following steps: having the network interface receive a customer id code and transaction information from a vendor device, which connects to the network; verifying the received customer id code; updating rewarding point information of a customer stored in the storage device according to the customer id code and the transaction information; updating rewarding point information of a vendor stored in the storage device according to the transaction information, wherein the vendor is corresponding to the vendor device; and having the network interface notify the vendor device with regard to the updating of the rewarding point information of the vendor.

According to an embodiment of the present application, a server computer for rewarding point redeeming is provided. The server computer comprising: a network interface, configured to connect to a network; a storage device, configured to store data; and a processor, coupled to the network interface and the storage device, configured to execute instructions stored in a non-volatile memory for fulfilling following steps: having the network interface receive a vendor id code and redeeming information from a customer device; verifying the received vendor id code; updating rewarding point information of a customer stored in the storage device according to the redeeming information, wherein the customer is corresponding to the customer device; updating redeeming information of a vendor stored in the storage device according to the vendor id code and the redeeming information; and having the network interface notify the customer device with regard to the updating of the rewarding point information of the customer.

According to an embodiment of the present application, a computing system for rewarding points accumulating is provided. The computer system comprising the server computer, the customer device and the vendor device as described.

According to an embodiment of the present application, a computing system for rewarding points redeeming is provided. The computer system comprising the server computer, the customer device and the vendor device as described.

Based on the server computer, system and methods for rewarding point accumulating and redeeming; it enables that customers of the alliance can accumulate from and can redeem rewarding points to different vendors in the alliance. This provides great incentive of the rewarding point program provided by the alliance.

### BRIEF DESCRIPTION OF THE DRAWINGS

The advantages and spirit related to the present invention can be further understood via the following detailed description and drawings.

FIG. 1 depicts a block diagram of a management system 100 in accordance with an embodiment of the present application.

FIG. 2 depicts a software block diagram of a management system 200 in accordance with an embodiment of the present application.

FIG. 3 depicts a data structure corresponding to a customer in accordance with an embodiment of the present application.

FIG. 4 depicts a data structure corresponding to a vendor in an alliance in accordance with an embodiment of the present application.

FIG. 5 depicts a flowchart diagram of a rewarding point accumulating method 500 in accordance with an embodiment of the present application.

FIG. 6 depicts a flowchart diagram of a rewarding point accumulating method 600 in accordance with an embodiment of the present application.

FIG. 7 depicts a flowchart diagram of a rewarding point accumulating method 700 in accordance with an embodiment of the present application.

FIG. 8 depicts a flowchart diagram of a rewarding point redeeming method 800 in accordance with an embodiment of the present application.

FIG. 9 depicts a flowchart diagram of a rewarding point redeeming method 900 in accordance with an embodiment of the present application.

FIG. 10 depicts a flowchart diagram of a rewarding point redeeming method 1000 in accordance with an embodiment of the present application.

FIG. 11 shows a flowchart diagram of a dynamically presenting id code method 1100 in accordance with an embodiment of the present application.

FIG. 12 shows a flowchart diagram of a dynamically generating id code method 1200 in accordance with an embodiment of the present application.

FIG. 13 shows a flowchart diagram of an advertisement rewarding method 1300 in accordance with an embodiment of the present application.

FIG. 14 shows a flowchart diagram of an advertisement rewarding method 1400 in accordance with an embodiment of the present application.

### DETAILED DESCRIPTION OF THE PREFERRED EMBODIMENT

Some embodiments of the present application are described in details below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

A rewarding point program provided by the present application is to have a plurality of vendors as a vendor alliance providing various kinds of services and goods so as that rewarding points issued by a first vendor can be redeemed by a second vendor. For example, if rewarding points issued by a toy store can be redeemed in a coffee shop for a free beverage and vice versa, it would largely increase incentives of the rewarding points. As a number of vendors of the alliance increases, kinds of services and goods provided by the alliance also increase, the rewarding points are getting more beneficial and attractive to customers of the alliance.

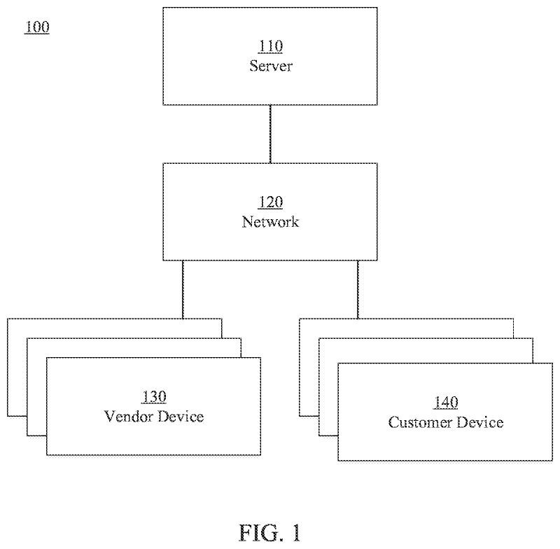

Please refer to FIG. 1, which depicts a block diagram of a management system 100 in accordance with an embodiment of the present application. The management system 100 may comprises a server 110, a network 120, a plurality of vendor devices 130 and a plurality of customer devices 140. The server 110 can be accessed by the vendor devices 130 and the customer devices 140 via the network 120. The network 120 may be a wide-area network such as Internet or any other interconnecting networks including wired or wireless access networks (PSTN, xDSL, 3G, 4G, 5G, 6G wireless telecommunication networks, satellite networks, WiFi, and WLAN) and backbone telecommunication networks.

As their names suggest, the vendor devices 130 and the customer devices 140 are computer devices for operators or clerks of vendors in an alliance and for customers of the alliance, respectively. The vendor devices 130 and the customer devices 140 may be computer devices such as smart watches, smart phones, personal digital assistants, tablet computers, lap top computers, personal computers, industrial computers, and the like. In additional to networking devices used to connect to the network 120, the vendor devices 130 and the customer devices 140 may include input devices such as touch pad, touch screen, keyboard, mouse, track balls, camera, bar code scanner, NFC (near-field communication) reader and etc. The vendor devices 130 and the customer devices 140 may comprise output devices such as display, touch screen, light indicator, speaker, vibrator, printer and etc. An operating system may be executed by a central processor unit of the vendor device 130 or the customer device 140 for controlling operations of the vendor device 130 or the customer device 140. Person having ordinary skill in the field of computer shall understand that users can utilize the input devices and the output devices to interact with the vendor devices 130 and the customer devices 140.

The server 110 comprises networking device for connecting to the network 120 and one or more processors for servicing computations provided by the present application. Person having ordinary skill in the field of computer shall understand that the server 110 may be implemented in a form of cluster, a form of server farms, a form of virtual servers and the like.

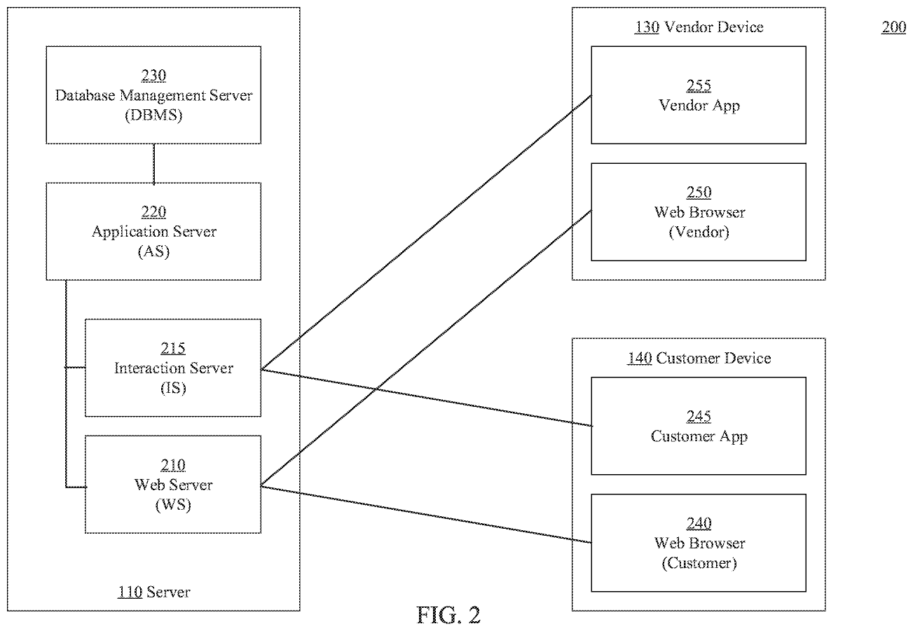

Please refer to FIG. 2, which depicts a software block diagram of a management system 200 in accordance with an embodiment of the present application. For convenience, the network 120 is omitted in FIG. 2. The server 110 may comprise three tiers of servers. Each tier may include its own hardware and software for implementations.

A tier of DBMS (database management server) 230 is majorly used to persistently store data involved in the server 110. For examples, the DBMS 210 may be one of existing database systems such as relational database systems. An access tier may comprise a web server 210 and/or a interaction server 215. The access tier is used to communicate with client programs. The web server 210 utilizes industrial standard HTML and TCP/IP protocols to communicate with web browsers 240 and 250. The interaction server 215 may utilize a special designed protocol to communicate with a customer App run at the customer device 140 and a vendor App run at the vendor device 130.

A middle tier for implementing logics and operations is resided in the Application Server 220 which connects to the DBMS 230 for accessing data and connects to the access tier for communicate with the clients. For examples, a software module deployed in the application server 220 may implement steps of a management method provided by the present invention. The middle tier may be also responsible for UI (user interface). For example, a responsive web design (RWD) of web pages may be implemented in order to fit into different sizes and resolutions of various web browsers 240 and 250. Although the server 110 as shown in FIG. 2 includes three tiers, person having ordinary in the art of computer shall understand that the present application does not limit how to implement the server 110. It may be implemented in other ways than the three tiers architecture as shown in FIG. 2.

The vendor device 130 may comprise one of the web browser 250 and the vendor App 255 to interact with the server 110. The web browser 250 may be an existing browser such as Microsoft Edge, Google Chrome, Apple Safari or the like. However, the web browser 250 may be put into a logic sandbox which is not authorized to access all of the input devices and output devices and computing resources of the vendor device 130. As a special tailored application program installed in the vendor device 130, the vendor App 255 is usually authorized to access all of the input devices and output devices and computing resources of the vendor device 130.

Similar to the vendor device 130, the customer device 140 may comprise one of the web browser 240 and the customer App 245 to interact with the server 110. The web browser 240 may be an existing browser such as Microsoft Edge, Google Chrome, Apple Safari or the like. However, the web browser 240 may be put into a logic sandbox which is not authorized to access all of the input devices and output devices and computing resources of the customer device 140. As a special tailored application program installed in the customer device 140, the customer App 245 is usually authorized to access all of the input devices and output devices and computing resources of the customer device 140.

Participating vendors of the alliance managed by the management system agree with commercial terms for issuing and redeeming rewarding points to customers of the alliance. Therefore, the alliance includes two kinds of members, i.e., vendors and customers. The server 110 stores member information of these two kinds of members. In an example, the member information is stored in the DBMS 230. A unique identification code (UUID) may be assigned to each member. No two members share the same identification code (or id code in short).

In addition to member information, rewarding point information with regard to the members is also stored in the server 110. From a customer's view, a customer at least needs to know how many rewarding points are accumulated. The vendor needs to know how many rewarding points were issued. Besides, the vendor also needs to know how many rewarding points were redeemed. For example, a first vendor issued 200 rewarding points to a customer and the customer redeemed the 200 rewarding points to a second vendor for exchanging a 20 dollar goods. The exchange rate of rewarding points versus dollars is 10:1. Therefore the first vendor has to pay 20 dollars to the second vendor to compensate the redeemed rewarding points.

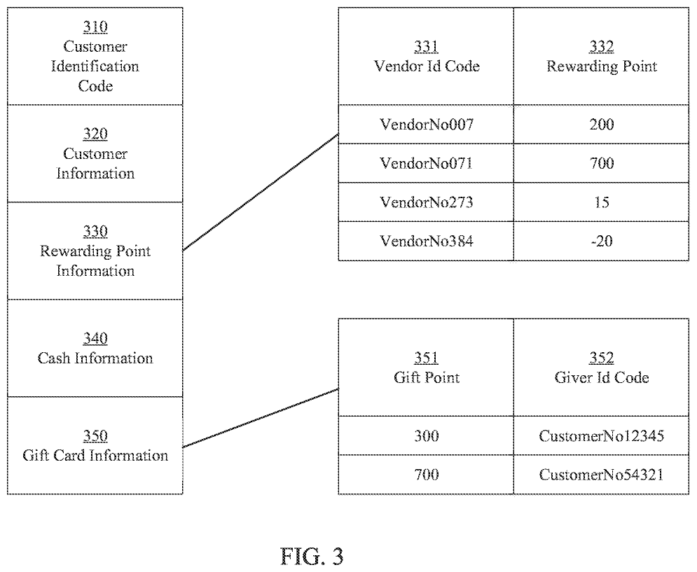

Please refer to FIG. 3, which depicts a data structure corresponding to a customer in accordance with an embodiment of the present application. For each customer, there is a field of customer identification code 310 for representing the customer, at least one field of customer information 320 and at least one field of rewarding point information 330. Optionally, for each customer there may be a field of cash information 340 and a field of gift card information. The customer information 320 may further include customer's name, password, address, email address, phone number, date of membership and any other information associated with the customer.

The rewarding point information may include a field for storing how many rewarding points that the customer have currently. Besides, there may exists additional historical records of which vendor gave rewarding points to the customer. For examples, in a historical record, a vendor ID code field 331 and a rewarding point field 332 are provided. As shown in FIG. 3, “VendorNo007” gave 200 rewarding points to the customer. “VendorNo071” gave 700 rewarding points to the customer. And “VendorNo273” gave 15 rewarding points to the customer. Hence, the customer currently has accumulated 915 rewarding points if the customer did not redeem them. Moreover, the rewarding point information may also include how the customer redeems the rewarding points.

The optional cash information 340 may be used to store the customer's cash deposit. Like the rewarding points, the customer may spend cash to buy services or goods provided by vendors of the alliance. Besides, the deposit may be “cashed out.”

The optional gift card information 350 may be used to store the customer's gift points. There may exists additional historical records of which giver gave gift points to the customer. For examples, in a first historical record, 200 gift points is given by “CustomerNo12345” to the customer. In a second historical record, 700 gift points is given by “CustomerNo54321” to the customer. Hence, the customer currently has accumulated 900 gift points if the customer did not redeem them.

In an embodiment, a difference between the gift point and the rewarding point may be that the gift points are only redeemed by a particular vendor and the rewarding points can be redeemed by all vendors of the alliance. In another embodiment, a difference between the gift point and the rewarding point may be that the gift points are only redeemed for a particular service or goods and the rewarding points can be redeemed for all services or goods provided by vendors of the alliance. Generally, redeeming of the gift points are more restricted than redeeming of the rewarding points.

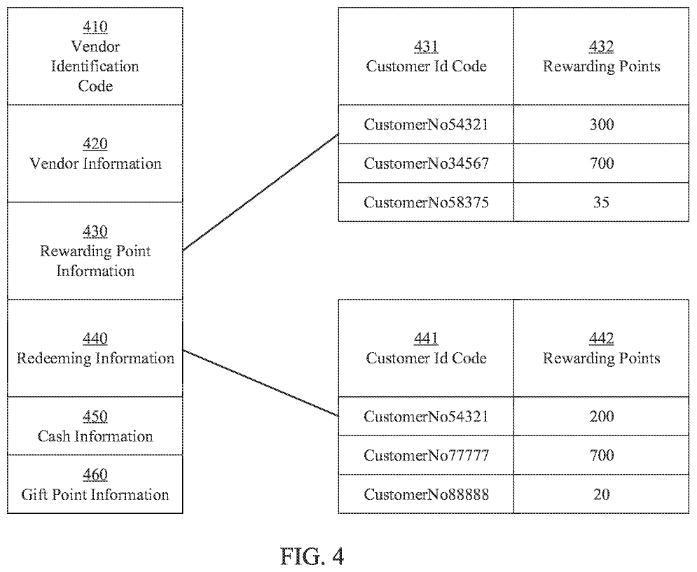

Please refer to FIG. 4, which depicts a data structure corresponding to a vendor in an alliance in accordance with an embodiment of the present application. For each vendor, there is a field of vendor identification code 410 for representing the vendor and at least one field of vendor information 420. The vendor information 420 may further include vendor name, password, address, email address, phone number, date of membership and any other information associated with the vendor.

For each vendor, there may be a field of rewarding point information 430 and a field of redeeming information 440. The field of rewarding point information 430 is used to store how many rewarding points the vendor rewarded its customers. As shown in FIG. 4, there are three customers rewarded by the vendor. The sum of the rewarding points rewarded is how many the vendor needs to pay. A sum of the three rewards is 1035. The vendor has to pay for 1035 rewarding points. The field of redeeming information 440 is used to store how many rewarding points are redeemed by the vendors. As shown in FIG. 4, there are two customers redeemed their rewarding points. A sum of these two redeeming is 900. The vendor can get paid for these 900 rewarding points from other vendors in the alliance.

The optional cash information 450 may be used to store the vendor's cash deposit. The deposit may be used to pay for the rewarding points the vendor gives. In the other hand, when received payment from other vendors for the rewarding points, the received money may be stored in the cash deposit. The optional gift information 460 may be used to store the vendor's sold and redeemed gift card information.

Next, a rewarding point accumulation embodiment would be elaborated based on the data structures as shown in FIGS. 3 and 4. This embodiment involves the three parties as shown in FIG. 1. When a customer buys services and/or goods from a vendor, this transaction would make some rewarding points are accumulated to the customer. In this transaction, the customer gets benefits for receiving rewarding points from the vendor. In addition to interactions between the customer device 140 and the vendor device 130, the server 110 is also required to be involved in the accumulation of rewarding points.

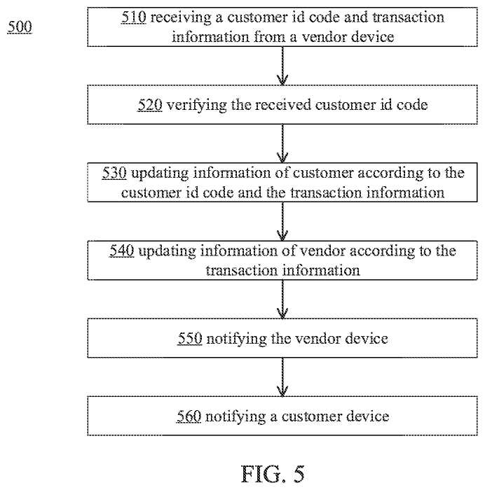

Please refer to FIG. 5, which depicts a flowchart diagram of a rewarding point accumulating method 500 in accordance with an embodiment of the present application. The rewarding point accumulating method 500 is implemented by the server 110 as shown in FIG. 1. In one example, the rewarding point accumulating method 500 is implemented by the three tiers of the server 110 as shown in FIG. 2. The rewarding point accumulating method 500 may be implemented as instructions and data executed by the server 110 as shown in FIGS. 1 and 2. If there is no causal relationship between any two given steps, the present application does not limit execution order of these two given steps. The flowchart begins at step 510.

Step 510: receiving customer id code and transaction information from a vendor device. The transaction information may include how many rewarding points would be rewarded from the vendor operating the vendor device. The server 110 may receive the customer id code and transaction information by the Web Server 210 or the Interaction Server 215 from the Web Browser 250 or the Vendor App 255.

Step 520: verifying the received customer id code. The Application Server 220 may verify whether the customer id code is valid in the DBMS 230. If the customer id code does not exist or is expired in the DBMS 230, the flow may end.

Step 530: updating information of customer according to the customer id code and the transaction information. In one first example, it is assumed that a 10 dollar purchase rewards 1 rewarding points. A customer buys a toy worth 1000 dollars. Therefore the customer would be given 100 rewarding points. The field of rewarding point information 330 would be updated at step 530 to reflect the increase of rewarding points. Besides, a new tuple of historical record including a vendor Id code field 331 and a rewarding point field 332 may be also added to reflect this transaction.

In a second example, it is assumed that 1 rewarding point is redeemed as 1 dollar. The customer wants to redeem all of his 100 rewarding points recorded in the corresponding field of rewarding point information 330 in the 1000 dollar toy transaction. This means that the customer only needs to pay 900 dollar in this transaction. In addition, the 900 dollar payment further rewards 90 rewarding points. Therefore the customer would have 90 rewarding points recorded in the corresponding field of rewarding point information 330 after the transaction.

Step 540: updating information of vendor according to the transaction information. In the first example, the field of rewarding information 430 is updated to reflect the 100 rewarding points given in the transaction. Optionally, a new tuple of historical record including a customer Id Code 431 and a rewarding point field 432 may be also added to reflect this transaction. In the second example, the redeeming information field 440 is updated to reflect the decrease of 100 rewarding points and the increase of 90 rewarding points. Optionally, a new tuple of historical record including a customer Id Code 441 and a rewarding point field 442 with regard to the redeeming may be also added to reflect the redeeming

From a view of DBMS, the updating steps 530 and 540 must be seen as a transaction with ACID (atomicity, consistency, isolation, durability) properties. If anything goes wrong in the steps 530 and 540, the transaction must be rolled back. The DBMS 230 of the server 110 may be responsible for the ACID transaction implementation of the updating steps 530 and 540.

Step 550: notifying a vendor device with the results of updating. The results would be reflected in the Vendor App 255 or in the Web Browser 250.

Step 560: notifying a customer device with the results of updating. The results would be reflected in the Customer App 245 or in the Web Browser 240.

In one embodiment, the customer may place cash in his/her account or receive a gift card. The number of cash and the gift card may be included in the transaction information. The step 530 may also comprise updating the cash information field 340 and/or the gift card information field 350 of the customer according to the transaction information.

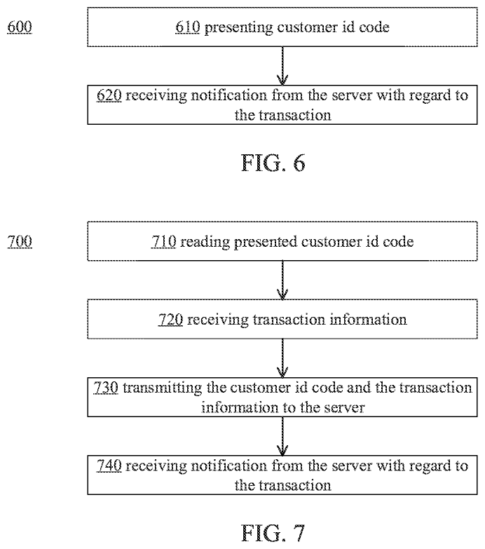

Please refer to FIG. 6, which depicts a flowchart diagram of a rewarding point accumulating method 600 in accordance with an embodiment of the present application. The rewarding point accumulating method 600 is implemented by the customer device 140 as shown in FIG. 1. In one example, the rewarding point accumulating method 600 is implemented by the Customer App 245 installed in the customer device 140 as shown in FIG. 2. The rewarding point accumulating method 600 may be implemented as instructions and data executed as the Customer App 245 as shown in FIG. 2. In another example, the rewarding point accumulating method 600 is implemented by the Web Browser 240 installed in the customer device 140 as shown in FIG. 2. However, the behavior of the Web Browser 240 is determined by web pages and programs downloaded from the Web Server 210 of the server 110. If there is no causal relationship between any two given steps, the present application does not limit execution order of these two given steps. The flowchart begins at step 610.

Step 610: presenting customer id code. The customer id code of the customer operating the customer device 140 may be encoded as a machine readable code, such as a one-dimensional bar code or a two-dimensional QR (quick response) code. Alternatively, the customer id code may be presented as a human-readable code including symbols such as English alphabets (e.g., a˜z) and Arabic numbers (e.g., 0˜9). The human-readable code may be also read and recognized by the reader hardware or software of the vendor device 130. For examples, the vendor device 130 may comprise a camera or a bar code reader to read the human-readable code or the machine-readable code. The vendor device 130 may recognize the read code to recover the customer id code presented by the customer device 140. Reading the customer id code by the vendor device 130 implies that the customer agrees with the transaction. And the vendor device 130 may further process the transaction.

In an alternative embodiment, in order to keep the customer id code confidential, the customer id code may not be a static visible code but a modulated signal. The signal may be modulated and/or encoded in any currently known way. For examples, the signal may be a modulated RF (radio frequency) signal which can be read in accordance with industrial standard NFC (near field communication) or RFID (radio frequency identification) protocols. The signal may be an audible signal modulated by DTMF (dual tone mutual frequency) protocol used in telephone communication. In short, the customer device 140 comprises signal modulator and the vendor device 130 comprises corresponding signal demodulator to transmit customer id code. The modulation and demodulation may further comprise error detection and/or correction mechanism to reduce transmission error probabilities and to reduce interferences effects during transmission.

Next, after the customer id code is presented to the vendor device 130, the transaction would be processed in the vendor device 130 and the server 110. At step 560 as shown in FIG. 5, the server 110 would notify the customer. Hence, at corresponding step 620 as shown in FIG. 6, the customer device 140 may receive the notification from the server 110 with regard to the transaction. Information stored in the rewarding point information field 330 as shown in FIG. 3 may be enclosed in the notification.

Please refer to FIG. 7, which depicts a flowchart diagram of a rewarding point accumulating method 700 in accordance with an embodiment of the present application. The rewarding point accumulating method 700 is implemented by the vendor device 130 as shown in FIG. 1. In one example, the rewarding point accumulating method 700 is implemented by the Vendor App 255 installed in the vendor device 130 as shown in FIG. 2. The rewarding point accumulating method 700 may be implemented as instructions and data executed as the Vendor App 255 as shown in FIG. 2. In another example, the rewarding point accumulating method 700 is implemented by the Web Browser 250 installed in the vendor device 130 as shown in FIG. 2. However, the behavior of the Web Browser 250 is determined by web pages and programs downloaded from the Web Server 210 of the server 110. If there is no causal relationship between any two given steps, the present application does not limit execution order of these two given steps. The flowchart begins at step 710.

Step 710: reading presented customer id code. The customer id code is presented at step 610. Thus, at step 710, the vendor device 130 equipped with a corresponding reader is used to read the customer id code presented by the customer device 140. Already discussed at step 610, the customer id code may be presented in a form which is readable and recognized by the corresponding reader of the vendor device 130.

Step 720: receiving transaction information. Clerk or operator of the vendor may input transaction information (e.g. transaction amount or rewarding points) via input devices of the vendor device 130. Or a business machine of the vendor which is used to receive the transaction information transmits the information to the vendor device 130.

Step 730: transmitting the customer id code and the transaction information to the server 110. This transmission is implemented via the network 120. The server 110 receives the customer id code and the transaction information at step 510 of the rewarding point accumulating method 500.

Step 740: receiving notification from the server with regard to the transaction. The notification is sent by the server 110 at step 550 of the rewarding point accumulating method 500.

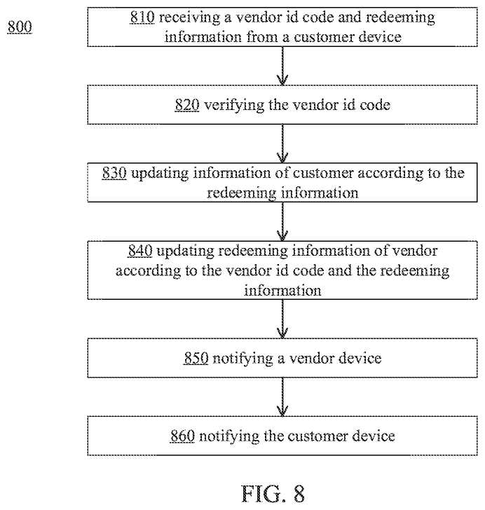

As shown in FIGS. 5, 6 and 7, three rewarding points accumulating methods 500, 600 and 700 are performed by the server 110, the customer device 140 and the vendor device 130, respectively, to realize operations for accumulating rewarding points. In this embodiment for accumulating rewarding points, it requires the customer to present the customer id code. Reversely, in an embodiment as shown in FIGS. 8, 9 and 10 for redeeming rewarding points, it requires the vendor to present the vendor id code.

Please refer to FIG. 8, which depicts a flowchart diagram of a rewarding point redeeming method 800 in accordance with an embodiment of the present application. The rewarding point redeeming method 800 is implemented by the server 110 as shown in FIG. 1. In one example, the rewarding point redeeming method 800 is implemented by the three tiers of the server 110 as shown in FIG. 2. The rewarding point redeeming method 800 may be implemented as instructions and data executed by the server 110 as shown in FIGS. 1 and 2. If there is no causal relationship between any two given steps, the present application does not limit execution order of these two given steps. The flowchart begins at step 810.

Sep 810: receiving a vendor id code and redeeming information from a customer device. The redeeming information may include how many rewarding points would be redeemed from the customer operating the customer device to the vendor represented by the vendor id code. The server 110 may receive the vendor id code and redeeming information by the Web Server 210 or the Interaction Server 215 from the Web Browser 240 or the Customer App 245.

Step 820: verifying the received vendor id code. The Application Server 220 may verify whether the vendor id code is valid in the DBMS 230. If the vendor id code does not exist or is expired in the DBMS 230, the flow may end.

Step 830: updating information of customer according to the redeeming information. The rewarding points of the customer would be decreased according to the redeeming information. In the embodiment as shown in FIG. 3, a customer redeems 20 rewarding points to “VendorNo384”. In one embodiment, a customer cannot have a negative number of rewarding points. For example, a customer has 10 rewarding points cannot redeem 20 rewarding points. However, in another embodiment, a customer may “borrow” rewarding points to redeem in advance.

Step 840: updating redeeming information of vendor according to the vendor id code and the redeeming information. In the embodiment as shown in FIG. 4, a vendor receives 20 rewarding points redeemed from CustomerNo88888.

From a view of DBMS, the updating steps 830 and 840 must be seen as a transaction with ACID (atomicity, consistency, isolation, durability) properties. If anything goes wrong in the steps 830 and 840, the transaction must be rolled back. The DBMS 230 of the server 110 may be responsible for the ACID transaction implementation of the updating steps 830 and 840.

Step 850: notifying vendor with the results of updating. The results would be reflected in the Vendor App 255 or in the Web Browser 250.

Step 860: notifying customer with the results of updating. The results would be reflected in the Customer App 245 or in the Web Browser 240.

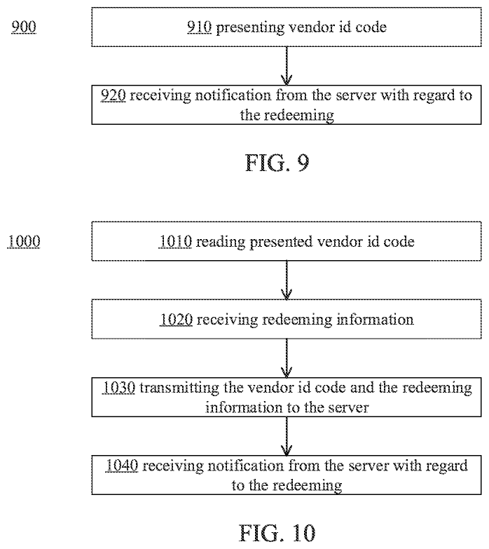

Please refer to FIG. 9, which depicts a flowchart diagram of a rewarding point redeeming method 900 in accordance with an embodiment of the present application. The rewarding point redeeming method 900 is implemented by the vendor device 130 as shown in FIG. 1. In one example, the rewarding point redeeming method 900 is implemented by the Vendor App 255 installed in the vendor device 130 as shown in FIG. 2. The rewarding point redeeming method 900 may be implemented as instructions and data executed as the Vendor App 255 as shown in FIG. 2. In another example, the rewarding point redeeming method 900 is implemented by the Web Browser 250 installed in the vendor device 130 as shown in FIG. 2. However, the behavior of the Web Browser 250 is determined by web pages and programs downloaded from the Web Server 210 of the server 110. If there is no causal relationship between any two given steps, the present application does not limit execution order of these two given steps. The flowchart begins at step 910.

Step 910: presenting vendor id code. Similar to the customer id code described at step 610, the vendor id code of the vendor operating the vendor device 130 may be encoded as a machine readable code, such as a one-dimensional bar code or a two-dimensional QR (quick response) code. Alternatively, the vendor id code may be presented as a human-readable code including symbols such as English alphabets (e.g., a˜z) and Arabic numbers (e.g., 0˜9). The human-readable code may be also read and recognized by the reader hardware or software of the vendor device 130. For examples, the customer device 140 may comprise a camera or a bar code reader to read the human-readable code or the machine-readable code. The customer device 140 may recognize the read code to recover the customer id code presented by the vendor device 130. Reading the vendor id code by the customer device 140 implies that the customer agrees with the transaction. And the customer device 140 may further process the redeeming.

In an alternative embodiment, in order to keep the vendor id code confidential, the vendor id code may not be a static visible code but a modulated signal. The signal may be modulated and/or encoded in any currently known way. For examples, the signal may be a modulated RF (radio frequency) signal which can be read in accordance with industrial standard NFC (near field communication) or RFID (radio frequency identification) protocols. The signal may be an audible signal modulated by DTMF (dual tone mutual frequency) protocol used in telephone communication. In short, the vendor device 130 comprises signal modulator and the customer device 140 comprises corresponding signal demodulator to transmit customer id code. The modulation and demodulation may further comprise error detection and/or correction mechanism to reduce transmission error probabilities and to reduce interferences effects during transmission.

Next, after the vendor id code is presented to the customer device 140, the redeeming would be processed in the customer device 140 and the server 110. At step 850 as shown in FIG. 8, the server 110 would notify the vendor. Hence, at corresponding step 920 as shown in FIG. 9, the vendor device 130 may receive the notification from the server 110 with regard to the redeeming. Information stored in the redeeming information field 440 as shown in FIG. 4 may be enclosed in the notification.

Please refer to FIG. 10, which depicts a flowchart diagram of a rewarding point redeeming method 1000 in accordance with an embodiment of the present application. The rewarding point redeeming method 1000 is implemented by the customer device 140 as shown in FIG. 1. In one example, the rewarding point redeeming method 1000 is implemented by the Customer App 245 installed in the customer device 140 as shown in FIG. 2. The rewarding point redeeming method 1000 may be implemented as instructions and data executed as the Customer App 245 as shown in FIG. 2. In another example, the rewarding point redeeming method 1000 is implemented by the Web Browser 240 installed in the customer device 140 as shown in FIG. 2. However, the behavior of the Web Browser 240 is determined by web pages and programs downloaded from the Web Server 210 of the server 110. If there is no causal relationship between any two given steps, the present application does not limit execution order of these two given steps. The flowchart begins at step 1010.

Step 1010: reading presented vendor id code. The vendor id code is presented at step 910. Thus, at step 1010, the customer device 140 equipped with a corresponding reader is used to read the vendor id code presented by the vendor device 130. Already discussed at step 910, the vendor id code may be presented in a form which is readable and recognized by the corresponding reader of the customer device 140.

Step 1020: receiving redeeming information. The customer may input redeeming information (e.g. number of rewarding points being redeemed) via input devices of the customer device 140. In one example, a reader of the customer device 140 may be used to scan a signal representing a redeem goods. A coffee shop may provide a menu with a vendor id code and dozens coffees and corresponding barcodes or QR codes, respectively. The customer may scan the vendor id code and one of the QR codes to redeem a cup of coffee corresponding to the scanned QR codes.

Step 1030: transmitting the vendor id code and the redeeming information to the server 110. This transmission is implemented via the network 120. The server 110 receives the vendor id code and the redeeming information at step 810 of the rewarding point redeeming method 800.

Step 1040: receiving notification from the server with regard to the transaction. The notification is sent by the server 110 at step 860 of the rewarding point redeeming method 800.

At steps 610 and 910, a vendor id code and a customer id code are presented by the vendor device 130 and the customer device 140, respectively. The signals representing the id codes may be stored in the vendor device 130 and the customer device 140. For examples, a picture file showing a bar code or a QR code is stored and being read at step 610 or step 910. Since the id code is fixed, the picture file is static information. It may be unsafe in some circumstances. Therefore it would be safer to present the id code by a dynamically generated signal.

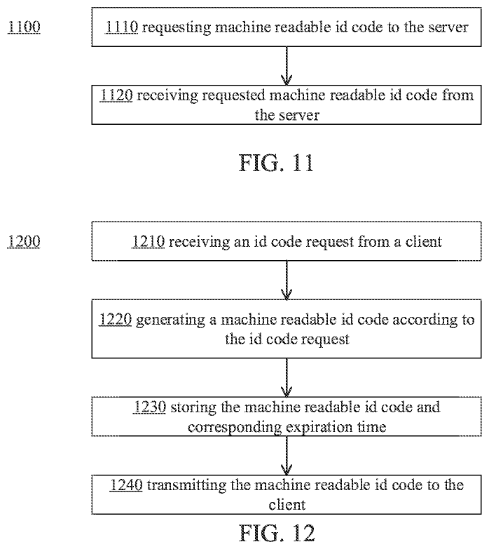

Please refer to FIG. 11, which shows a flowchart diagram of a dynamically presenting id code method 1100 in accordance with an embodiment of the present application. The dynamically presenting id code method 1100 may be a part of the above mentioned step 610 or step 910. The dynamically presenting id code method 1100 may be implemented by the vendor device 130 and/or the customer device 140 as shown in FIG. 1. In one example, the dynamically presenting id code method 1100 may be implemented by the Customer App 245 installed in the customer device 140 as shown in FIG. 2. In one example, the dynamically presenting id code method 1100 may be implemented by the Vendor App 255 installed in the vendor device 130 as shown in FIG. 2. In another example, the dynamically presenting id code method 1100 is implemented by the Web Browser 250 installed in the vendor device 130 and/or the Web Browser 240 installed in the customer device 140 as shown in FIG. 2. However, the behavior of the Web Browser 240 and/or the Web Browser 250 is determined by web pages and programs downloaded from the Web Server 210 of the server 110. If there is no causal relationship between any two given steps, the present application does not limit execution order of these two given steps. The flowchart begins at step 1110.

Step 1110: requesting machine readable id code to the server. The customer device 140 or the vendor device 130 may request id code representing the customer id code or the vendor id code by providing credential (e.g., id and password) to the server 110. In one example, the request would be encrypted and transmitted via the network 120. After receiving the request, the server 110 would dynamically generate a signal representing the requested machine readable id code and sent it back.

Step 1120: receiving requested machine readable id code from the server 110. The received machine readable id code may be also encrypted. Therefore the step 1120 may further comprise decrypting the requested machine readable id code to be presented at step 610 or step 910. Furthermore, the requested machine readable id code may be also modulated for being presented.

Please refer to FIG. 12, which shows a flowchart diagram of a dynamically generating id code method 1200 in accordance with an embodiment of the present application. The dynamically generating id code method 1200 is corresponding to the dynamically presenting id code method 1100 as shown in FIG. 11. The dynamically generating id code method 1200 is implemented by the server 110 as shown in FIG. 1. In one example, the dynamically generating id code method 1200 is implemented by the three tiers of the server 110 as shown in FIG. 2. The dynamically generating id code method 1200 may be implemented as instructions and data executed by the server 110 as shown in FIGS. 1 and 2. If there is no causal relationship between any two given steps, the present application does not limit execution order of these two given steps. The flowchart begins at step 1210.

Step 1210: receiving an id code request from a client. The client may be one of the customer device 140 and the vendor device 130. The id code request may be come from step 1110 as shown in FIG. 11. Optionally, the id code request may be accompanied with a credential corresponding to the id code being requested.

Step 1220: generating a machine readable id code according to the id code request. Upon the request is received, the server 110 dynamically generates the machine readable id code according to the id code request from the client. In one example, the credential of the requester or the client shall be corresponding to the requested id code. In short, a customer or a vendor can only request his/her own machine readable id code. The server 110 can only generate the machine readable id code of the requester. Moreover, the machine readable id code may be a modulated signal as discussed above.

Furthermore, an expiration time may be added into the generated machine readable id code. For example, a few-minute duration is given into the generated machine readable id code. Once the client (a customer or a vendor) has to present the machine readable id code to his/her counterpart at step 610 or step 910 in the duration. The expiration duration may be predetermined or customizable. The machine readable id code may comprise a start time of the duration. Or alternatively, the machine readable id code may comprise an expiration time of the duration. The flow may proceed to step 1240. In one instance, the generated machine readable id code does not comprise the start time or the expiration time of the duration. The server 110 needs to store the generated machine id code and corresponding expiration time. The flow proceeds to step 1230.

Optional step 1230: storing the machine readable id code and corresponding expiration time. In one example, the server 110 may store the start time of the duration or the expiration time of the duration.

Step 1240: transmitting the machine readable id code to the client.

Now referring back to the step 520 as shown in FIG. 5. At step 520, the verifying may further comprise checking whether the customer id code is expired or not. When the customer id code comprises the start time or the expiration time of the duration, the verifying may further check the current time with the start time or the expiration time of the duration. When the start time or the expiration time of the duration is stored at optional step 1230, the verifying may further check the current time and the start time or the expiration time of the duration previously stored at step 1230. If the customer id code is expired at step 520, the flow as shown in FIG. 5 may proceed to step 550 and step 560 for notifying the vendor and the customer with regard to the expiration of the customer id code, respectively.

Similarly, at step 820 as shown in FIG. 8, the verifying may further comprise checking whether the vendor id code is expired or not. When the vendor id code comprises the start time or the expiration time of the duration, the verifying may further check the current time and the start time or the expiration time of the duration. When the start time or the expiration time of the duration is stored at optional step 1230, the verifying may further check the current time with the start time or the expiration time of the duration previously stored at step 1230. If the vendor id code is expired at step 820, the flow as shown in FIG. 8 may proceed to step 850 and step 860 for notifying the vendor and the customer with regard to the expiration of the vendor id code, respectively.

In addition to purchase from the vendors, there may be alternative ways to gain rewarding points. For example, the customer may download and view online advertisements to win rewarding points. The advertisement materials may include web pages, static pictures, sounds, motion pictures, games or any application programs to be installed. The server 110 may be configured to store and to distribute the advertisement materials. However, it does not limit that the advertisement materials have to be stored in the server 110.

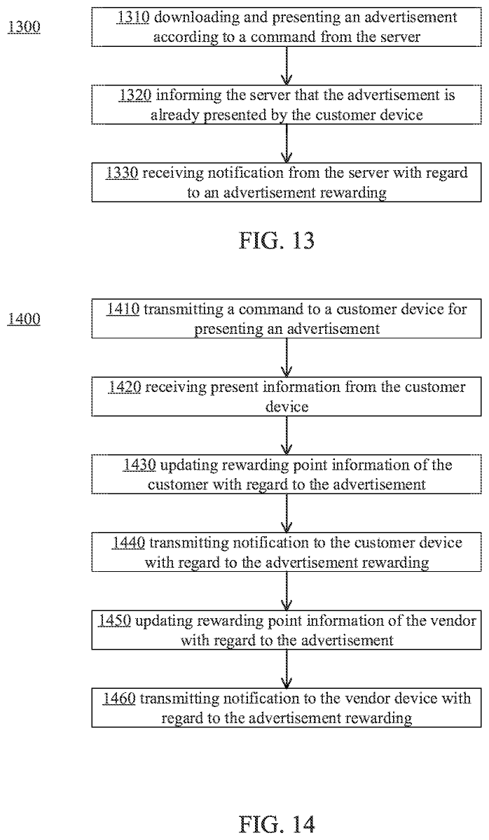

Please refer to FIG. 13, which shows a flowchart diagram of an advertisement rewarding method 1300 in accordance with an embodiment of the present application. The advertisement rewarding method 1300 may be implemented by the customer device 140 as shown in FIG. 1. In one example, the advertisement rewarding method 1300 may be implemented by the Customer App 245 installed in the customer device 140 as shown in FIG. 2. In another example, the advertisement rewarding method 1300 is implemented by the Web Browser 240 installed in the customer device 140 as shown in FIG. 2. However, the behavior of the Web Browser 240 is determined by web pages and programs downloaded from the Web Server 210 of the server 110. If there is no causal relationship between any two given steps, the present application does not limit execution order of these two given steps. The flowchart begins at step 1310.

Step 1310: downloading and presenting an advertisement according to a command from the server. Depending on types of the advertisement materials contained in the advertisement, the presenting may comprises displaying web pages, pictures or motion pictures on a screen of the customer device 140, playing by a speaker of the customer device 140, executing games or application programs by the customer device 140, and etc.

Step 1320: informing the server that the advertisement is presented by the customer device 140. The advertisement rewarding may be given only when the advertisement is presented by the customer device 140. Hence the step 1320 may be performed after the step 1310 is completed.

Step 1330: receiving notification from the server with regard to an advertisement rewarding. The advertisement rewarding may comprise some rewarding points added to the rewarding point information field 330 as shown in FIG. 3 corresponding to the customer operating the customer device 140. The advertisement rewarding may be provided by a vendor in the alliance. However, it does not limit that the advertisement rewarding has to be paid by a vendor in the alliance.

Please refer to FIG. 14, which shows a flowchart diagram of an advertisement rewarding method 1400 in accordance with an embodiment of the present application. The advertisement rewarding method 1400 is corresponding to the advertisement rewarding method 1300 as shown in FIG. 13. The advertisement rewarding method 1400 is implemented by the server 110 as shown in FIG. 1. In one example, the advertisement rewarding method 1400 is implemented by the three tiers of the server 110 as shown in FIG. 2. The advertisement rewarding method 1400 may be implemented as instructions and data executed by the server 110 as shown in FIGS. 1 and 2. If there is no causal relationship between any two given steps, the present application does not limit execution order of these two given steps. The flowchart begins at step 1410.

Step 1410: transmitting a command to a customer device for presenting an advertisement. This step 1410 is corresponding to the step 1310.

Step 1420: receiving present information from the customer device. This step 1420 is corresponding to the step 1320.

Step 1430: updating rewarding point information of the customer with regard to the advertisement. The rewarding point information field 330 of the customer may be updated at this step.

Step 1440: transmitting notification to the customer device with regard to the advertisement rewarding. If rewarding points included in the advertisement rewarding is provided by a vendor in the alliance. The flow may further include optional steps 1450 and 1460.

Optional step 1450: updating rewarding point information of the vendor with regard to the advertisement. The rewarding point information field 430 of the vendor may be updated at this step.

Optional step 1460. transmitting notification to the vendor device with regard to the advertisement rewarding.

According to an embodiment of the present application, a rewarding point accumulating method is provided. The rewarding point accumulating method, comprising: receiving a customer id code and transaction information from a vendor device; verifying the received customer id code; updating rewarding point information of a customer according to the customer id code and the transaction information; updating rewarding point information of a vendor according to the transaction information, wherein the vendor is corresponding to the vendor device; and notifying the vendor device with regard to the updating of the rewarding point information of the vendor.

Preferably, in order to let the customer be aware of the result of rewarding point updating with regard to the purchase, the method further comprises notifying a customer device operated by the customer with regard to the updating of the rewarding point information of the customer.

Preferably, in order to make sure of that the purchase between the vendor and the customer is real, the method further comprises: presenting the customer id code by a customer device operated by the customer; reading the presented customer id code by the vendor device; and receiving the transaction information by the vendor device.

Preferably, in order to provide secure transaction by dynamically generating customer id code, the method further comprises following steps before the presenting step: receiving an id code request from the customer device; generating the customer id code according to the id code request; and transmitting the customer id code to the customer device.

Preferably, in order to provide one-time id code validation mechanism, the customer id code is generated with a valid time information, wherein the verifying step further comprises: determining whether received customer id code is expired or not according to the valid time information and a current time; and when the received customer id code is expired, notifying the vendor device that the received customer id code is expired.

Preferably, in order to provide one-time id code validation mechanism, the method further comprises storing a valid time information corresponding to the customer id code, wherein the verifying step further comprises: determining whether received customer id code is expired or not according to the stored valid time information and a current time; and when the received customer id code is expired, notifying the vendor device that the received customer id code is expired.

Preferably, in order to provide convenient input options, the customer id code is presented by a signal which is modulated in one of following forms: a machine readable visual code; a man readable visual code; a bar code; and a QR (quick reaction) code.

Preferably, in order to provide versatile payment options, the method further comprises one of following steps: updating gift card information of the customer according to the customer id code and the transaction information; and updating cash information of the customer according to the customer id code and the transaction information.

Preferably, in order to provide advertisement rewarding mechanism, the method further comprises: transmitting a command to a customer device operated by the customer for presenting an advertisement; downloading and presenting the advertisement according to the command by the customer device; receiving present information of the advertisement from the customer device; updating the rewarding point information of the customer with regard to rewarding points corresponding to the advertisement; and notifying the customer device with regard to the updating of the rewarding point information of the customer with regard to rewarding points corresponding to the advertisement.

Preferably, in order to provide advertisement rewarding mechanism to vendors in the alliance, the method further comprises: updating the rewarding point information of a second vendor with regard to the rewarding points corresponding to the advertisement; and notifying a second vendor device with regard to the updating of the rewarding point information of the second vendor with regard to the rewarding points corresponding to the advertisement.

According to an embodiment of the present application, a rewarding point redeeming method is provided. The rewarding point redeeming method, comprising: receiving a vendor id code and redeeming information from a customer device; verifying the received vendor id code; updating rewarding point information of a customer according to the redeeming information, wherein the customer is corresponding to the customer device; updating redeeming information of a vendor according to the vendor id code and the redeeming information; and notifying the customer device with regard to the updating of the rewarding point information of the customer.

Preferably, in order to let the vendor be aware of the result of rewarding point updating with regard to the redeeming, the method further comprises notifying a vendor device operated by the vendor with regard to the updating of the redeeming information of the customer.

Preferably, in order to make sure of that the redeeming between the vendor and the customer is real, the method further comprises: presenting the vendor id code by a vendor device operated by the vendor; reading the presented customer id code by the customer device; and receiving the redeeming information by the customer device.

Preferably, in order to provide secure redeeming by dynamically generating vendor id code, the method further comprises following steps before the presenting step: receiving an id code request from the vendor device; generating the vendor id code according to the id code request; and transmitting the vendor id code to the vendor device.

Preferably, in order to provide one-time id code validation mechanism, the vendor id code is generated with a valid time information, wherein the verifying step further comprises: determining whether received vendor id code is expired or not according to the valid time information and a current time; and when the received vendor id code is expired, notifying the customer device that the received vendor id code is expired.

Preferably, in order to provide one-time id code validation mechanism, the method further comprises storing a valid time information corresponding to the vendor id code, wherein the verifying step further comprises: determining whether received vendor id code is expired or not according to the stored valid time information and a current time; and when the received vendor id code is expired, notifying the customer device that the received vendor id code is expired.

Preferably, in order to provide convenient input options, the vendor id code is presented by a signal which is modulated in one of following forms: a machine readable visual code; a man readable visual code; a bar code; and a QR (quick reaction) code.

Preferably, in order to provide advertisement rewarding mechanism, the method further comprises: transmitting a command to the customer device operated by the customer for presenting an advertisement; downloading and presenting the advertisement according to the command by the customer device; receiving present information of the advertisement from the customer device; updating the rewarding point information of the customer with regard to rewarding points corresponding to the advertisement; and notifying the customer device with regard to the updating of the rewarding point information of the customer with regard to rewarding points corresponding to the advertisement.

Preferably, in order to provide advertisement rewarding mechanism to vendors in the alliance, the method further comprises: updating the rewarding point information of a second vendor with regard to the rewarding points corresponding to the advertisement; and notifying a second vendor device with regard to the updating of the rewarding point information of the second vendor with regard to the rewarding points corresponding to the advertisement.

According to an embodiment of the present application, a server computer for rewarding point accumulating is provided. The server computer comprising: a network interface, configured to connect to a network; a storage device, configured to store data; and a processor, coupled to the network interface and the storage device, configured to execute instructions stored in a non-volatile memory for fulfilling following steps: having the network interface receive a customer id code and transaction information from a vendor device, which connects to the network; verifying the received customer id code; updating rewarding point information of a customer stored in the storage device according to the customer id code and the transaction information; updating rewarding point information of a vendor stored in the storage device according to the transaction information, wherein the vendor is corresponding to the vendor device; and having the network interface notify the vendor device with regard to the updating of the rewarding point information of the vendor.

Preferably, in order to let the customer be aware of the result of rewarding point updating with regard to the purchase, the processor is further configured for having the network interface notify a customer device operated by the customer with regard to the updating of the rewarding point information of the customer.

Preferably, in order to make sure of that the purchase between the vendor and the customer is real and to provide secure transaction by dynamically generating customer id code, the customer id code is presented by a customer device operated by the customer, the presented customer id code is read by the vendor device, and the transaction information is received by the vendor device, wherein the processor is further configured for fulfilling following steps before the presenting step: having the network interface receive an id code request from the customer device; generating the customer id code according to the id code request; and having the network interface transmit the customer id code to the customer device.

Preferably, in order to provide one-time id code validation mechanism, the customer id code is generated with a valid time information, wherein the verifying step further comprises: determining whether received customer id code is expired or not according to the valid time information and a current time; and when the received customer id code is expired, having the network interface notify the vendor device that the received customer id code is expired.

Preferably, in order to provide one-time id code validation mechanism, the processor is further configured for having the storage device store a valid time information corresponding to the customer id code, wherein the verifying step further comprises: determining whether received customer id code is expired or not according to the stored valid time information and a current time; and when the received customer id code is expired, having the network interface notify the vendor device that the received customer id code is expired.

Preferably, in order to provide convenient input options, the customer id code is presented by a signal which is modulated in one of following forms: a machine readable visual code; a man readable visual code; a bar code; and a QR (quick reaction) code.

Preferably, in order to provide versatile payment options, the processor is further configured for fulfilling one of following steps: updating gift card information of the customer stored in the storage device according to the customer id code and the transaction information; and updating cash information of the customer stored in the storage device according to the customer id code and the transaction information.

Preferably, in order to provide advertisement rewarding mechanism, the processor is further configured for fulfilling following steps: having the network interface transmit a command to a customer device operated by the customer for presenting an advertisement, so as the customer device downloads and presents the advertisement; having the network interface receive present information of the advertisement from the customer device; updating the rewarding point information of the customer with regard to rewarding points corresponding to the advertisement; and having the network interface notify the customer device with regard to the updating of the rewarding point information of the customer with regard to rewarding points corresponding to the advertisement.

Preferably, in order to provide advertisement rewarding mechanism to vendors in the alliance, the processor is further configured for fulfilling following steps: updating the rewarding point information of a second vendor stored in the storage device with regard to the rewarding points corresponding to the advertisement; and having the network interface notify a second vendor device with regard to the updating of the rewarding point information of the second vendor with regard to the rewarding points corresponding to the advertisement.

According to an embodiment of the present application, a server computer for rewarding point redeeming is provided. The server computer comprising: a network interface, configured to connect to a network; a storage device, configured to store data; and a processor, coupled to the network interface and the storage device, configured to execute instructions stored in a non-volatile memory for fulfilling following steps: having the network interface receive a vendor id code and redeeming information from a customer device; verifying the received vendor id code; updating rewarding point information of a customer stored in the storage device according to the redeeming information, wherein the customer is corresponding to the customer device; updating redeeming information of a vendor stored in the storage device according to the vendor id code and the redeeming information; and having the network interface notify the customer device with regard to the updating of the rewarding point information of the customer.

Preferably, in order to let the vendor be aware of the result of rewarding point updating with regard to the redeeming, the processor is further configured for having the network interface notify a vendor device operated by the vendor with regard to the updating of the redeeming information of the customer.

Preferably, in order to make sure of that the redeeming between the vendor and the customer is real and to provide secure redeeming by dynamically generating vendor id code, the vendor id code is presented by a vendor device operated by the vendor, the presented vendor id code is read by the customer device, and the redeeming information is received by the customer device, wherein the processor is further configured for fulfilling following steps before the presenting step: having the network interface receive an id code request from the vendor device; generating the vendor id code according to the id code request; and having the network interface transmit the vendor id code to the vendor device.

Preferably, in order to provide one-time id code validation mechanism, the vendor id code is generated with a valid time information, wherein the verifying step further comprises: determining whether received vendor id code is expired or not according to the valid time information and a current time; and when the received vendor id code is expired, having the network interface notify the customer device that the received vendor id code is expired.

Preferably, in order to provide one-time id code validation mechanism, the processor is further configured for storing a valid time information corresponding to the vendor id code, wherein the verifying step further comprises: determining whether received vendor id code is expired or not according to the stored valid time information and a current time; and when the received vendor id code is expired, having the network interface notify the customer device that the received vendor id code is expired.

Preferably, in order to provide convenient input options, the vendor id code is presented by a signal which is modulated in one of following forms: a machine readable visual code; a man readable visual code; a bar code; and a QR (quick reaction) code.

Preferably, in order to provide advertisement rewarding mechanism, the processor is further configured for fulfilling following steps: having the network interface transmit a command to the customer device operated by the customer for presenting an advertisement so as the customer device downloads and presents the advertisement; having the network interface receive present information of the advertisement from the customer device; updating the rewarding point information of the customer stored in the storage device with regard to rewarding points corresponding to the advertisement; and having the network interface notify the customer device with regard to the updating of the rewarding point information of the customer with regard to rewarding points corresponding to the advertisement.

Preferably, in order to provide advertisement rewarding mechanism to vendors in the alliance, the processor is further configured for fulfilling following steps: updating the rewarding point information of a second vendor stored in the storage device with regard to the rewarding points corresponding to the advertisement; and having the network interface notify a second vendor device with regard to the updating of the rewarding point information of the second vendor with regard to the rewarding points corresponding to the advertisement.

According to an embodiment of the present application, a computing system for rewarding points accumulating is provided. The computer system comprising the server computer, the customer device and the vendor device as described.

According to an embodiment of the present application, a computing system for rewarding points redeeming is provided. The computer system comprising the server computer, the customer device and the vendor device as described.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A server computer for rewarding point accumulating, comprising:
a network interface, configured to connect to a network;
a storage device, configured to store data; and
a processor, coupled to the network interface and the storage device, configured to execute instructions stored in a non-volatile memory for fulfilling following steps:
having the network interface receive a customer id code and transaction information from a vendor device, which connects to the network;
verifying the received customer id code;
updating rewarding point information of a customer stored in the storage device according to the customer id code and the transaction information;
updating rewarding point information of a vendor stored in the storage device according to the transaction information, wherein the vendor is corresponding to the vendor device; and
having the network interface notify the vendor device with regard to the updating of the rewarding point information of the vendor.

2. The server computer as claimed in claim 1, wherein the processor is further configured for having the network interface notify a customer device operated by the customer with regard to the updating of the rewarding point information of the customer.

3. The server computer as claimed in claim 1, wherein the customer id code is presented by a customer device operated by the customer, the presented customer id code is read by the vendor device, and the transaction information is received by the vendor device, wherein the processor is further configured for fulfilling following steps before the presenting step:
having the network interface receive an id code request from the customer device;
generating the customer id code according to the id code request; and
having the network interface transmit the customer id code to the customer device.

4. The server computer as claimed in claim 3, wherein the customer id code is generated with a valid time information, wherein the verifying step further comprises:
determining whether received customer id code is expired or not according to the valid time information and a current time; and
when the received customer id code is expired, having the network interface notify the vendor device that the received customer id code is expired.

5. The server computer as claimed in claim 3, wherein the processor is further configured for having the storage device store a valid time information corresponding to the customer id code, wherein the verifying step further comprises:
determining whether received customer id code is expired or not according to the stored valid time information and a current time; and
when the received customer id code is expired, having the network interface notify the vendor device that the received customer id code is expired.

6. The server computer as claimed in claim 3, wherein the customer id code is presented by a signal which is modulated in one of following forms:
a machine readable visual code;
a man readable visual code;
a bar code; and
a QR (quick reaction) code.

7. The server computer as claimed in claim 3, wherein the processor is further configured for fulfilling one of following steps:
updating gift card information of the customer stored in the storage device according to the customer id code and the transaction information; and
updating cash information of the customer stored in the storage device according to the customer id code and the transaction information.

8. The server computer as claimed in claim 1, wherein the processor is further configured for fulfilling following steps:
having the network interface transmit a command to a customer device operated by the customer for presenting an advertisement, so as the customer device downloads and presents the advertisement;
having the network interface receive present information of the advertisement from the customer device;
updating the rewarding point information of the customer with regard to rewarding points corresponding to the advertisement; and
having the network interface notify the customer device with regard to the updating of the rewarding point information of the customer with regard to rewarding points corresponding to the advertisement.

9. The server computer as claimed in claim 8, wherein the processor is further configured for fulfilling following steps:
updating the rewarding point information of a second vendor stored in the storage device with regard to the rewarding points corresponding to the advertisement; and
having the network interface notify a second vendor device with regard to the updating of the rewarding point information of the second vendor with regard to the rewarding points corresponding to the advertisement.

10. A server computer for rewarding point redeeming, comprising:
a network interface, configured to connect to a network;
a storage device, configured to store data; and
a processor, coupled to the network interface and the storage device, configured to execute instructions stored in a non-volatile memory for fulfilling following steps:
having the network interface receive a vendor id code and redeeming information from a customer device;
verifying the received vendor id code;
updating rewarding point information of a customer stored in the storage device according to the redeeming information, wherein the customer is corresponding to the customer device;
updating redeeming information of a vendor stored in the storage device according to the vendor id code and the redeeming information; and
having the network interface notify the customer device with regard to the updating of the rewarding point information of the customer.

11. The server computer as claimed in claim 10, wherein the processor is further configured for having the network interface notify a vendor device operated by the vendor with regard to the updating of the redeeming information of the customer.

12. The server computer as claimed in claim 10, wherein the vendor id code is presented by a vendor device operated by the vendor, the presented vendor id code is read by the customer device, and the redeeming information is received by the customer device, wherein the processor is further configured for fulfilling following steps before the presenting step:
having the network interface receive an id code request from the vendor device;
generating the vendor id code according to the id code request; and
having the network interface transmit the vendor id code to the vendor device.

13. The server computer as claimed in claim 12, wherein the vendor id code is generated with a valid time information, wherein the verifying step further comprises:
determining whether received vendor id code is expired or not according to the valid time information and a current time; and
when the received vendor id code is expired, having the network interface notify the customer device that the received vendor id code is expired.

14. The server computer as claimed in claim 12, wherein the processor is further configured for storing a valid time information corresponding to the vendor id code, wherein the verifying step further comprises:
determining whether received vendor id code is expired or not according to the stored valid time information and a current time; and
when the received vendor id code is expired, having the network interface notify the customer device that the received vendor id code is expired.

15. The server computer as claimed in claim 12, wherein the vendor id code is presented by a signal which is modulated in one of following forms:
a machine readable visual code;
a man readable visual code;
a bar code; and
a QR (quick reaction) code.

16. The server computer as claimed in claim 10, wherein the processor is further configured for fulfilling following steps:
having the network interface transmit a command to the customer device operated by the customer for presenting an advertisement so as the customer device downloads and presents the advertisement;
having the network interface receive present information of the advertisement from the customer device;
updating the rewarding point information of the customer stored in the storage device with regard to rewarding points corresponding to the advertisement; and
having the network interface notify the customer device with regard to the updating of the rewarding point information of the customer with regard to rewarding points corresponding to the advertisement.

17. The server computer as claimed in claim 16, wherein the processor is further configured for fulfilling following steps:
updating the rewarding point information of a second vendor stored in the storage device with regard to the rewarding points corresponding to the advertisement; and
having the network interface notify a second vendor device with regard to the updating of the rewarding point information of the second vendor with regard to the rewarding points corresponding to the advertisement.
